(19) United States
(12) Patent Application Publication
(10) Pub. No.: US 2020/0219351 A1
(43) Pub. Date: Jul. 9, 2020

(54) VOTE AUTHENTICATION SERVER, VOTE SERVER AND ELECTRONIC VOTING SYSTEM

(71) Applicant: INDUSTRY-UNIVERSITY COOPERATION FOUNDATION HANYANG UNIVERSITY ERICA CAMPUS, Ansan-si (KR)

(72) Inventors: Sung-Hyun Cho, Seoul (KR); Chi-Young Jeong, Ansan-si (KR); Yong-Seok Kwon, Suwon-si (KR); Soo-Hyeong Kim, Seoul (KR); Min-Geon Ju, Seoul (KR)

(73) Assignee: INDUSTRY-UNIVERSITY COOPERATION FOUNDATION HANYANG UNIVERSITY ERICA CAMPUS, Ansan-si (KR)

(21) Appl. No.: 16/735,168

(22) Filed: Jan. 6, 2020

(30) Foreign Application Priority Data
Jan. 7, 2019 (KR) 10-2019-0001817

(51) Int. Cl. G07C 13/00

(52) U.S. Cl. CPC G07C 13/00

(57) ABSTRACT

Provided is a vote authentication server. The vote authentication server includes a communication unit configured to receive a vote authority authentication request information transmitted from a voter terminal; a vote token management unit configured to issue a vote token according to vote authority authentication, provide the vote token to the voter terminal, and receive the vote token from the voter terminal when a voting is completed; a vote token identification unit configured to assign an identification code to the issued vote token and store the identification code of the issued vote token; and a block chain unit configured to create a block of an authentication block chain network using the vote token provided from the voter terminal and the vote token provided to the voter terminal.

### BACKGROUND OF THE INVENTION

### 1. Field of the Invention

The present invention relates to a vote authentication server, a vote server, and an electronic voting system, and more particularly, to a vote authentication server, a vote server, and an electronic voting system in which security of vote value information is enhanced by creating a block chain network.

### 2. Description of the Prior Art

The bitcoin began in 2008 in a paper published by an unidentified person named Satoshi Nakamoto. The bitcoin is an electronic currency that is issued, stored and distributed over a distributed network rather than a centralized organization such as a government or bank. The bitcoin was first published in 2009 and maintains the value of money until now without a centralized institution, and the number of users and transactions is steadily increasing.

A block chain technology is the background for maintaining the monetary value of the bitcoin. The block chain refers to a technology that maintains security and integrity in a decentralized network environment without a centralized server. In other words, the block chain maintains the integrity of transactions without a central management institution by making it impossible for any user to forge or falsify data. Accordingly, research for applying block chain to various fields has recently been actively conducted.

### SUMMARY OF THE INVENTION

A technical purpose of the present invention is to provide a vote authentication server, a vote server, and an electronic voting system in which data forgery or falsification can be prevented.

Another technical purpose of the present invention is to provide a vote authentication server, a vote server, and an electronic voting system in which the principle of the equal election can be implemented.

Still another purpose of the present invention is to provide a vote authentication server, a vote server, and an electronic voting system in which the principle of the secret election can be implemented.

Still another purpose of the present invention is to provide a vote authentication server, a vote server, and an electronic voting system in which reliability and security can be improved.

The objectives of the present invention are not limited to the above-described ones.

In order to solve the above technical problem, the present invention provides a vote authentication server including: a communication unit configured to receive vote authority authentication request information transmitted from a voter terminal; a vote token management unit configured to issue a vote token according to vote authority authentication, provide the vote token to the voter terminal, and receive the vote token from the voter terminal when a voting is completed; a vote token identification unit configured to assign an identification code to the issued vote token and store the identification code of the issued vote token; and a block chain unit configured to create a block of an authentication block chain network using the vote token provided from the voter terminal and the vote token provided to the voter terminal.

According to one embodiment, the vote token identification unit may be configured to compare the identification code of the vote token provided to the voter terminal with the identification code of the vote token provided from the voter terminal to check whether a voter votes or not.

According to one embodiment, a block of the authentication block chain network may be created through a practical byzantine fault tolerance (PBFT) consensus algorithm.

According to one embodiment, the vote token management unit may be configured to transmit the vote token provided to the voter terminal to a vote server that receives a vote value.

According to one embodiment, the vote authentication server ma further include an encryption unit, wherein the encryption unit may be configured to encrypt the vote token provided to the voter terminal using a voter display key and an authentication server private key received from the voter terminal.

According to one embodiment, a vote result from the voter terminal is not received in the vote authentication server.

According to one embodiment, the vote token management unit may be configured to grant one vote token to one voter in order to implement a principle of an equal election.

A vote server according to one embodiment of the present invention includes: a vote value management unit configured to receive a vote value for a vote result from a voter terminal; and a vote server block chain unit configured to create a block of a vote server block chain network by using the vote value.

According to one embodiment, the vote server may further include a vote server vote token management unit configured to receive the vote token from an authentication server.

According to one embodiment, the block of the vote server block chain network may be created through a practical byzantine fault tolerance (PBFT) consensus algorithm.

According to one embodiment, the vote server may further include: a vote token management unit configured to receive the vote token from an authentication server, wherein the vote value management unit may be configured to receive the vote value and assign reliability to the vote value according to whether the vote token associated with the vote value matches the vote token received from the authentication server.

According to one embodiment, the vote value management unit may be configured to receive the vote value and the vote token associated with the vote value from the voter terminal such that a voter who creates the vote value is kept with a secret.

According to one embodiment, the vote value management unit may be configured to determine the vote value based on a difference in input values between an initial password input window and a vote password input window of the voter terminal.

An electronic voting system according to one embodiment of the present invention includes: an authentication server configured to issue a vote token according to a vote authority after receiving vote authority authentication request information transmitted from a voter terminal; and a vote server configured to receive the vote token from the authentication server and receive a vote value for a vote result from the voter terminal, wherein the voter terminal is configured to transmit a vote authority authentication request information to the authentication server, and receive the vote token from the authentication server before a voting, and provide the vote token to the authentication server and provide the vote value to the vote server when the voting is completed.

According to one embodiment, the authentication server may be configured to create a block of an authentication block chain network using the vote token provided from the voter terminal, the vote server may be configured to create a block of a vote block chain network using the vote value provided from the voter terminal, and the authentication block chain network and the vote block chain network may be separate block chain networks that are independent from each other.

The electronic voting system according to an embodiment of the present invention includes the voter terminal, the authentication server for issuing the vote token based on the vote authority after receiving vote authority authentication request information transmitted from the voter terminal, and the vote server that receives the vote token from the authentication server and receives the vote value for the vote result from the voter terminal, in which the voter terminal transmits the authority authentication request information to the authentication server and receives the vote token from the authentication server before the voting and provides the vote token to the authentication server and provides the vote value to the vote server when the voting is completed.

Accordingly, only the voters provided with the vote token through authentication can participate in the voting, and as one vote token is given to each voter, one person may exercise only one vote so that the principle of the equal election can be realized. In addition, since information on the right to vote (voter) and information on the vote value (voted candidate) are separately stored in the authentication server and the vote server, respectively, it is impossible to know information about the voter and the voted candidate, so that the principle of the secret election can be realized.

Further, the authentication server can create a block of the authentication block chain network by using the vote token provided from the voter terminal, and the vote server can create a block of the block chain network by using the vote value provided from the voter terminal. Accordingly, an electronic voting system with improved reliability and security can be provided.

### BRIEF DESCRIPTION OF THE DRAWINGS

The above and other objects, features, and advantages of the present invention will be more apparent from the following detailed description taken in conjunction with the accompanying drawings, in which: FIG. 1 is a view for explaining an electronic voting system according to an embodiment of the present invention.

FIG. 2 is a view for explaining a voter terminal according to an embodiment of the present invention.

FIG. 3 is a view for explaining a process of determining a vote value in a voter terminal according to an embodiment of the present invention.

FIG. 4 is a view for explaining an authentication server according to an embodiment of the present invention.

FIG. 5 is a view for explaining a vote server according to an embodiment of the present invention.

FIG. 6 is a view for explaining an encryption process and a decryption process between a voter terminal and an authentication server in an electronic voting system according to an embodiment of the present invention.

FIG. 7 is a view for explaining an encryption process and a decryption process between a voter terminal and a vote server in an electronic voting system according to an embodiment of the present invention.

FIG. 8 is a view for explaining an encryption process and a decryption process between an authentication server and a vote server in an electronic voting system according to an embodiment of the present invention.

FIG. 9 is a view for explaining an electronic voting method according to an embodiment of the present invention.

### DETAILED DESCRIPTION OF THE EXEMPLARY EMBODIMENTS

Hereinafter, preferred embodiments of the present invention will be described in detail with reference to the accompanying drawings. However, the technical spirit of the present invention is not limited to the embodiments, but may be realized in different forms. The embodiments introduced here are provided to sufficiently deliver the spirit of the present invention to those skilled in the art so that the disclosed contents may become thorough and complete.

When it is mentioned in the specification that one element is on another element, it means that the first element may be directly formed on the second element or a third element may be interposed between the first element and the second element. Further, in the drawings, the thicknesses of the membrane and areas are exaggerated for efficient description of the technical contents.

Further, in the various embodiments of the present invention, the terms such as first, second, and third are used to describe various elements, but the elements are not limited to the teams. The terms are used only to distinguish one element from another element. Accordingly, an element mentioned as a first element in one embodiment may be mentioned as a second element in another embodiment. The embodiments illustrated here include their complementary embodiments. Further, the term “and/or” in the specification is used to include at least one of the elements enumerated in the specification.

In the specification, the terms of a singular form may include plural foams unless otherwise specified. Further, the terms “including” and “having” are used to designate that the features, the numbers, the steps, the elements, or combination thereof described in the specification are present, and may be understood that one or more other features, numbers, step, elements, or combinations thereof may be added.

Further, in the specification, the expression ‘a constant length’ or ‘the same length’ may be understood as meaning ‘a substantially constant length’ or ‘substantially the same length’.

Further, in the following description of the present invention, a detailed description of known functions and configurations incorporated herein will be omitted when it may make the subject matter of the present invention unnecessarily unclear.

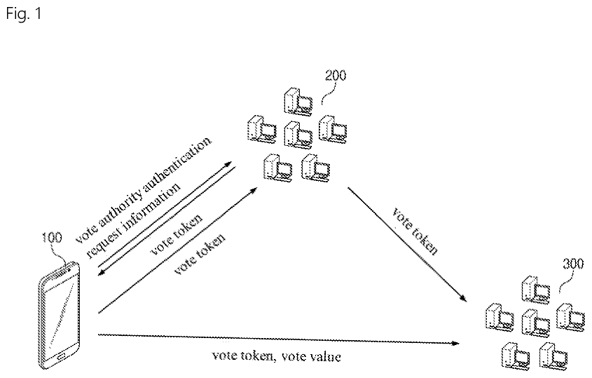

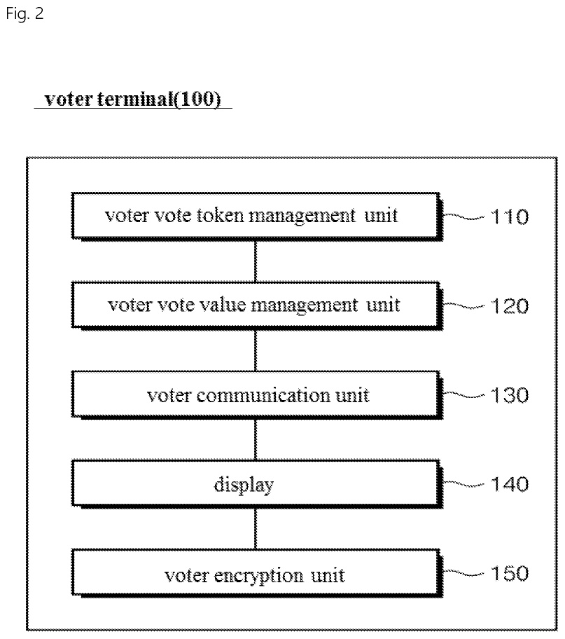

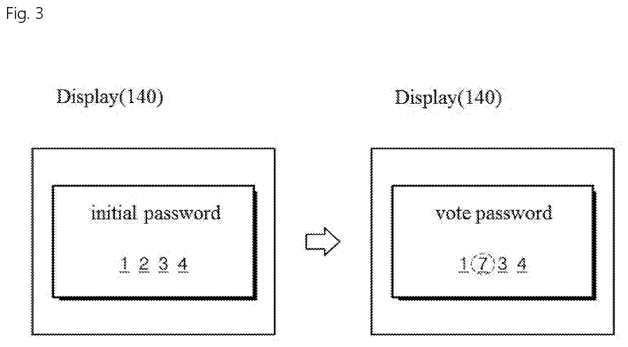

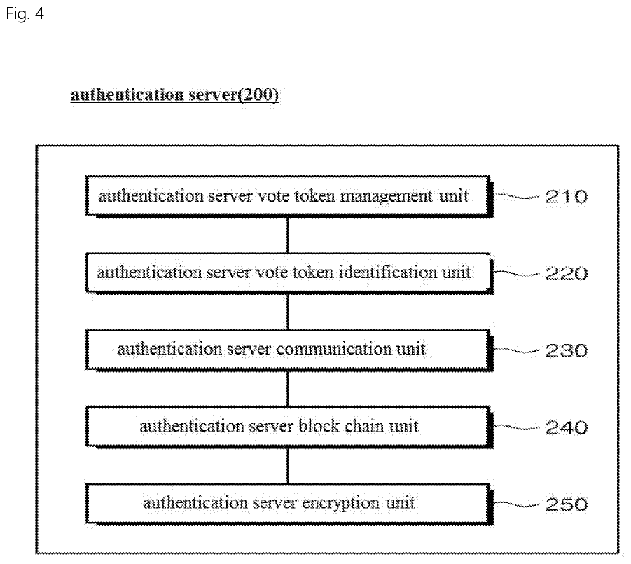

FIG. 1 is a view for explaining an electronic voting system according to an embodiment of the present invention, FIG. 2 is a view for explaining a voter terminal according to an embodiment of the present invention, FIG. 3 is a view for explaining a process of determining a vote value in a voter terminal according to an embodiment of the present invention, and FIG. 4 is a view for explaining an authentication server according to an embodiment of the present invention.

Referring to FIG. 1, an electronic voting system according to an embodiment of the present invention may include at least one of a voter terminal 100, an authentication server 200, and a vote server 300.

The voter terminal 100 may transmit vote authority authentication request information to the authentication server 200 before a voter votes. According to one embodiment, the voter terminal 100 may be a device for allowing a voter to vote, for example, a smartphone. In addition, the type of the voter terminal 100 is not limited.

After receiving the vote authority authentication request information, the authentication server 200 may determine whether there is vote authority, and if it is determined that there is vote authority, the authentication server 200 may issue a vote token. The issued vote token may be provided to the voter terminal 100. In addition, after receiving the vote token, the voter terminal 100 may provide the vote token back to the authentication server 200 when the voting of the voter is completed. In this case, the authentication server 200 may compare the vote token provided to the voter terminal 100 with the vote token provided from the voter terminal 100 to check whether a voter having the vote authority votes. That is, in the electronic voting system according to the embodiment, only the voters provided with the vote token through authentication can participate in the voting, and as one vote token is given to each voter, the voter may exercise only one vote. As a result, in the electronic voting system according to the embodiment, the principle of the equal election in which one person exercises one vote can be realized.

Meanwhile, when the voter completes the vote, the voter terminal 100 may transmit a vote value for the vote result of the voter to the vote server 300. Accordingly, the vote server 300 may check the vote result through the vote value.

According to one embodiment, the authentication server 200 may create a block of an authentication block chain network using the vote token provided from the voter terminal 100. That is, the authentication server 200 may receive the vote tokens from a plurality of the voter terminals 100, and create a block using the vote tokens. In addition, the authentication server 200 may create a block of the authentication block chain network by using the vote token provided to the voter terminal 100.

In other words, the authentication server 200 may generate a transaction for the vote tokens provided from the authentication server 200 or provided to the authentication server 200, and create a block by collecting the transactions. In addition, a plurality of blocks may be gathered to form a block chain network. In the case of a block chain network, it is necessary to hack all the blocks constituting the block chain network to forge and/or falsify data of one block.

However, hacking every block is actually impossible, so data may be safely kept from hacking in the case of a block chain network. As a result, the vote tokens stored in the authentication server 200 may be safely secured from hacking.

In addition, the vote server 300 may create a block of a vote block chain network by using the vote value provided from the voter terminal 100. That is, the vote server 300 may also receive the vote values from a plurality of voter terminals 100 and create a block chain network by using the vote values. Accordingly, the vote values stored in the vote server 300 may also be safely secured from hacking.

According to one embodiment, the block of the authentication block chain network and the block of the voting block chain network may be created through a practical byzantine fault tolerance (PBFT) consensus algorithm. The PBFT consensus algorithm may be divided into three stages of a pre-prepare stage where a node selected as a leader proposes a block to general nodes, a prepare stage where it is checked whether the same block is proposed to each node, and a commit stage where the proposed block is verified to vote. In this case, more than two-thirds of the nodes receive the same block and exercise the same vote in the prepare and commit stages, so it is possible to safely reach the consensus. Accordingly, the reliability and security of the electronic voting system according to the embodiment can be improved.

As described above, according to the electronic voting system of the embodiment, information on the right of vote (voter) is stored in the authentication server 200 and information on the vote value (voted candidate) may be stored in the vote server 300, so the right of vote and the vote value may be stored separately from each other. That is, the authentication server 200 may know information about the voter, but does not know information about the voted candidate. Meanwhile, the vote server 300 may know information about the voted candidate, but does not know information about the voter. Accordingly, the authentication server 200 and the vote server 300 may not know the information about the candidate voted by the voter, so the principle of the secret election may be realized. On the contrary, when information on the right of vote and information on the vote value are stored in one place, it is possible to know the information about the candidate voted by the voter, so the principle of the secret election may not be realized, and thus the reliability of the electronic voting system may be lowered.

Hereinafter, each component of the electronic voting system will be described in more detail with reference to FIGS. 2 to 5.

Referring to FIGS. 1 and 2, the voter terminal 100 may include a voter vote token management unit 110, a voter vote value management unit 120, a voter communication unit 130, a display 140, and a voter encryption unit 150.

The voter vote token management unit 100 may receive the vote token according to the vote authority authentication from the authentication server 200 before the voting, and may provide the vote token provided from the authentication server 200 back to the authentication server 200 when the voting is completed. In addition, the vote token provided from the authentication server 200 may be provided not only to the authentication server 200, but also to the vote server 300 when the voting is completed. The voter vote value management unit 120 may receive a vote value from a voter and transmit the inputted vote value to the vote server 300. The voter communication unit 130 may transmit vote authority authentication request information to the authentication server 200.

That is, the voter terminal 100 may transmit the vote authority authentication request information to the authentication server 200 through the voter communication unit 130, and then receive the vote token, which is issued according to the authentication in the authentication server 200, through the voter vote token management unit 110. In addition, when the voter completes the voting, the vote tokens may be provided from the voter terminal 100 to the authentication server 200 and the vote server 300, respectively, and the vote value may be provided to the vote server 300.

Referring to FIGS. 2 and 3, the voter vote value management unit 120 may output an initial password input window and a vote password input window through the display 140. In addition, the voter vote value management unit 120 may determine the vote value based on the difference in input values between the initial password input window and the vote password input window. More specifically, the voter vote value management unit 120 may determine the vote value based on a specific digit having a different value between an initial password, which is input through the initial password input window, and a vote password, which is input through the vote password input window.

According to one embodiment, when there are four candidates for the election, the initial password may have four digits. In this case, the vote password differs from the initial password only by one digit, and the rest may be input in the same manner. If the first digit is different between the initial password and the vote password, the vote value may be determined as the first candidate. Alternatively, if the second digit is different between the initial password and the vote password, the vote value may be determined as the second candidate. In addition, when the third digit or the fourth digit is different between the initial password and the vote password, the vote value may be determined as the third candidate or the fourth candidate. For example, as shown in FIG. 3, when the initial password is 1234 and the vote password is 1734, the vote value may be determined as the second candidate because the second digit is different.

That is, in the electronic voting system according to the embodiment, the vote value may be determined through the difference between the initial password and the vote password. Accordingly, even if an outsider watches the vote process during the vote process, the outsider may not know the vote value so that the security of the voting may be improved.

The voter encryption unit 150 may encrypt and decrypt the vote authority authentication request information, the vote token, and the vote value. In detail, the vote authority authentication request information and the vote token provided from the voter terminal 100 to the authentication server 200 may be transmitted in an encrypted state through the voter encryption unit 150, and the vote token, which is provided from the authentication server 200 in the encrypted state, may be decrypted through the voter encryption unit 150. In addition, the vote value provided from the voter terminal 100 to the vote server 300 may also be transmitted in an encrypted state through the voter encryption unit 150.

Referring to FIGS. 1 and 4, the authentication server 200 may include an authentication server vote token management unit 210, an authentication server vote token identification unit 220, an authentication server communication unit 230, an authentication server block chain unit 240, and an authentication server encryption unit 250.

The authentication server vote token management unit 210 may issue the vote tokens according to vote authority authentication, and provide the issued vote tokens to the voter terminal 100 and the vote server 300, respectively. In addition, the authentication server vote token management unit 210 may receive the vote token from the voter terminal 100 when the voting is completed.

The authentication server vote token identification unit 220 may assign an identification code to the issued vote tokens, and store the identification code of the issued vote tokens. For example, the identification code may be in the form of Unspent Transaction Output (UTxO). In addition, the authentication server vote token identification unit 220 may compare the identification code of the vote token provided to the voter terminal 100 with the identification code of the vote token provided from the voter terminal 100 to confirm whether the voter votes or not.

The authentication server communication unit 230 may receive the vote authority authentication request information transmitted from the voter terminal 100. That is, the authentication server 200 may receive the vote authority authentication request information through the authentication server communication unit 230, and if it is determined that there is vote authority, the authentication server 200 may issue the vote tokens through the authentication server vote token management unit 210 and assign the identification code to the issued vote tokens through the authentication server vote token identification unit 220. In addition, the vote tokens assigned with the identification code may be provided to the voter terminal 100 and the vote server 300 through the vote token management unit 210, respectively.

The authentication server block chain unit 240 may create a block of an authentication block chain network by using the vote token provided from the voter terminal 100. In addition, the authentication server block chain unit 240 may create a block of an authentication block chain network by using the vote token provided to the voter terminal 100. In this case, the authentication block chain network created by using the vote token provided from the voter terminal 100 may be different from the authentication block chain network created by using the vote token provided to the voter terminal 100. That is, the authentication server block chain unit 240 may store the vote tokens, which are provided from the authentication server 200 or provided to the authentication server 200, in the form of a block chain network.

The authentication server encryption unit 250 may encrypt and decrypt the vote authority authentication request information and the vote token. In detail, the encrypted vote authority authentication request information and the encrypted vote token provided from the voter terminal 100 to the authentication server 200 may be decrypted through the authentication server encryption unit 250. In addition, the vote tokens may be provided from the authentication server 200 to the voter terminal 100 and the vote server 300 in an encrypted state through the authentication server encryption unit 250.

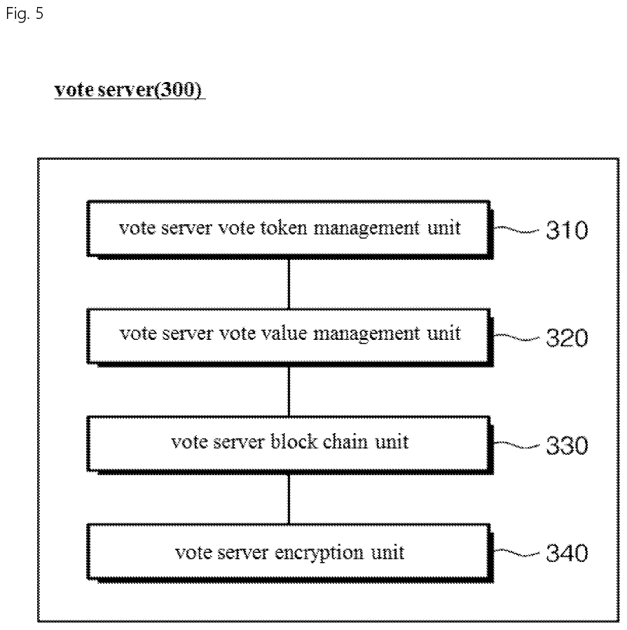

Referring to FIGS. 1 and 5, the vote server 300 may include a vote server vote token management unit 310, a vote server vote value management unit 320, a vote server block chain unit 330, and a vote server encryption unit 350.

The vote server vote token management unit 310 may receive the vote token from the voter terminal 100 and the authentication server 200. The vote server vote value management unit 320 may receive the vote value for the vote result from the voter terminal 100. The vote server block chain unit 330 may create a block of the vote block chain network by using the vote value provided from the voter terminal 100. The vote server encryption unit 340 may encrypt and decrypt the vote value and the vote token. In detail, the encrypted vote value and the encrypted vote token provided from the voter terminal 100 and the authentication server 200 may be decrypted.

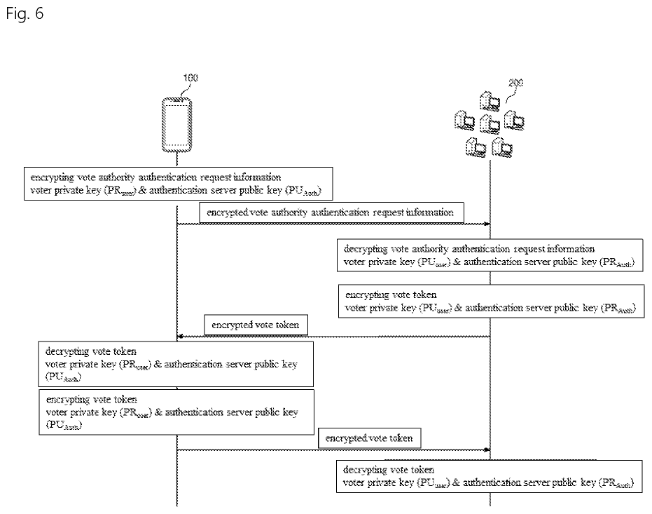

According to one embodiment, each of the voter encryption unit 150, the authentication server encryption unit 250, and the vote server encryption unit 340 may encrypt and decrypt the vote authority authentication request information, the vote token and the vote value through a private key and a public key. Hereinafter, the encryption process and the decryption process of the voter encryption unit 150, the authentication server encryption unit 250, and the vote server encryption unit 340 will be described in more detail with reference to FIGS. 6 to 8.

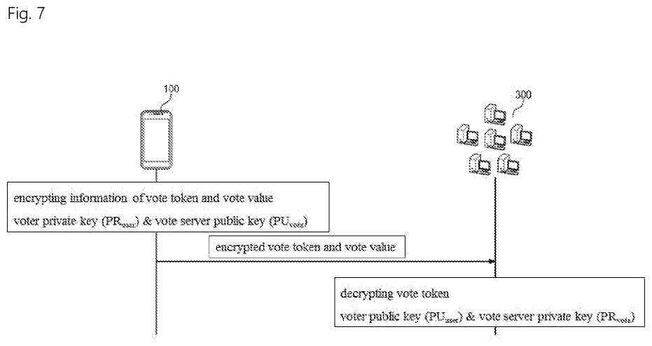

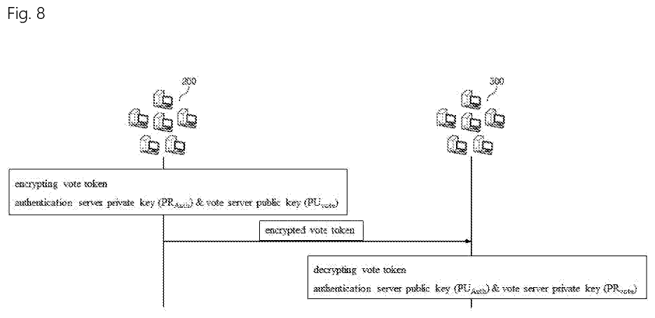

FIG. 6 is a view for explaining the encryption process and the decryption process between the voter terminal and the authentication server in the electronic voting system according to an embodiment of the present invention, FIG. 7 is a view for explaining the encryption process and the decryption process between the voter terminal and the vote server in the electronic voting system according to an embodiment of the present invention, and FIG. 8 is a view for explaining the encryption process and the decryption process between the authentication server and the vote server in the electronic voting system according to an embodiment of the present invention.

Referring to FIG. 6, the voter terminal 100 may encrypt the vote authority authentication request information in the voter encryption unit 150 by using a voter private key PRᵤₛₑᵣ and an authentication server public key PU_{Auth}. The encrypted vote authority authentication request information may be provided to the authentication server 200 and then decrypted in the authentication server encryption unit 250 by using a voter public key PUᵤₛₑᵣ and an authentication server private key PR_{Auth}

The authentication server 200 may issue the vote token after decrypting the encrypted vote authority authentication request information, and the vote token may be encrypted in the authentication server encryption unit 250 by using the voter public key PUᵤₛₑᵣ and the authentication server private key PR_{Auth}. The encrypted vote token may be provided to the voter terminal 100, and then decrypted in the voter encryption unit 150 by using the voter private key PRᵤₛₑᵣ and the authentication server public key PU_{Auth}. In addition, when the voting is completed, the decrypted vote token may be encrypted in the voter encryption unit 150 by using the voter private key PRᵤₛₑᵣ and the authentication server public key PU_{Auth} and the encrypted vote token may be provided to the authentication server 200. Thereafter, the vote token encrypted in the authentication server encryption unit 250 may be decrypted through the voter public key PUᵤₛₑᵣ and the authentication server private key PR_{Auth}.

Referring to FIG. 7, the voter terminal 100 may encrypt the vote token and the vote value in the voter encryption unit 150 by using the voter private key PRᵤₛₑᵣ and a vote server public key PUᵥₒₜₑ and the encrypted vote token and the encrypted vote value may be provided to the vote server 300. The vote server 300 may decrypt the encrypted vote token and the encrypted vote value in the vote server encryption unit 340 by using the voter public key PUᵤₛₑᵣ and a vote server private key PRᵥₒₜₑ.

Referring to FIG. 8, the authentication server 200 may encrypt the vote token in the authentication server encryption unit 250 by using an authentication server private key PR_{Auth} and the vote server public key PUᵥₒₜₑ, and may provide the encrypted vote token to the vote server 300. The vote server 300 may decrypt the encrypted vote token in the vote server encryption unit 340 by using an authentication server public key PU_{Auth} and the vote server private key PRᵥₒₜₑ.

The electronic voting system according to an embodiment of the present invention may include the voter terminal 100, the authentication server 200, which receives the vote authority request information transmitted from the voter terminal and issues the vote token based on the vote authority, and the vote server 300, which receives the vote token from the authentication server 200 and receives the vote value for the vote result from the voter terminal 100, in which the voter terminal 100 transmits the vote authority authentication request information to the authentication server 200 and receives the vote token from the authentication server 200 before the voting, and provides the vote token to the authentication server 200 and provides the vote value to the vote server 300 when the voting is completed.

Accordingly, only the voters provided with the vote token through authentication can participate in the voting, and as one vote token is given to each voter, the principle of the equal election where one person exercises one vote can be realized. In addition, since information on the right of vote (voter) and information on the vote value (voted candidate) may be separately stored in the authentication server 200 and the vote server 300, respectively, so it is impossible to know information about the candidate voted by the voter, thereby realizing the principle of the secret election.

In addition, the authentication server 200 may create a block of the authentication block chain network by using the vote token provided from the voter terminal 100, and the vote server 300 may create a block of the vote block chain network by using the vote value provided from the voter terminal 100. Accordingly, the electronic voting system with improved reliability and security can be provided.

The electronic voting system according to an embodiment of the present invention has been described above. Hereinafter, an electronic voting method according to an embodiment of the present invention will be described.

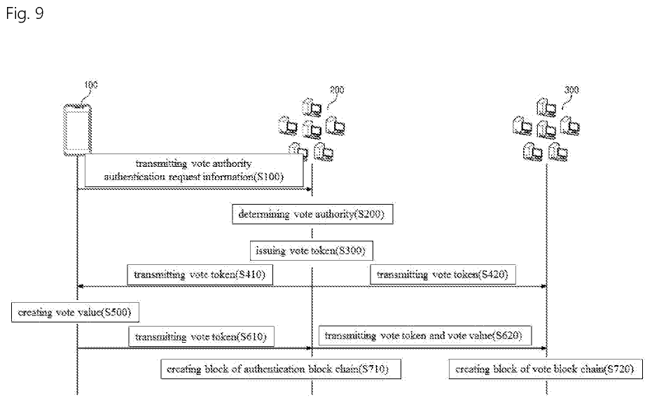

FIG. 9 is a view for explaining an electronic voting method according to an embodiment of the present invention. As shown in FIG. 9, the electronic voting method according to an embodiment of the present invention may include a step (S100) of transmitting the vote authority authentication request information to the authentication server 200 by the voter terminal 100. After receiving the vote authority authentication request information, the authentication server 200 may determine the vote authority based on the vote authority authentication request information (S200).

In vote authority determination step (S200), if it is determined that there is a vote authority, the authentication server 200 may issue a vote token (S300). The authentication server 200 may create a transaction for the issued vote token after issuing the vote token. The issued vote token may be provided to the voter terminal 100 (S410). In addition, the issued vote token may also be provided to the vote server 300 (S420).

When the vote token is provided to the voter terminal 100, the voter terminal 100 may perform the voting. In order to allow the voter terminal 100 to vote, the voter terminal 100 may create a vote value (S500).

When the voting is completed, the voter terminal 100 may provide the vote token to the authentication server 200 (S610). In addition, when the voting is completed, the voter terminal 100 may provide the vote token and the vote value to the vote server 300 (S620).

The authentication server 200 that receives the vote token may create a transaction by using the vote token, and create a block of an authentication block chain network (S710). Meanwhile, the vote server 300 that receives the vote value may create a block of the vote block chain network by using the vote value (S720).

According to one embodiment, after step S710, the authentication server 200 may compare the vote token provided from the authentication server 200 to the voter terminal 100 with the vote token provided from the voter terminal 100 to the authentication server 200. Accordingly, the authentication server 200 may check whether the voter votes or not.

That is, in the electronic voting system according to the embodiment, only voters provided with the vote tokens through authentication can participate in the voting, and as one vote token is given to each voter, the principle of the equal election where one person exercises one vote can be realized. In addition, the information on the right of vote (voter) and the information on the vote value (voted candidate) are separately stored in the authentication server 200 and the vote server 300, respectively, so it is impossible to know the information about the candidate voted by the voter, thereby realizing the principle of the secret election.

Although the preferred embodiments of the present invention have been described in detail until now, the scope of the present invention is not limited to the embodiments and should be construed by the attached claims. Further, it should be understood that those skilled in the art to which the present invention pertains may variously correct and modify the present invention without departing from the scope of the present invention.

What is claimed is:

1. A vote authentication server comprising:
a communication unit configured to receive vote authority authentication request information transmitted from a voter terminal;
a vote token management unit configured to issue a vote token according to vote authority authentication, provide the vote token to the voter terminal, and receive the vote token from the voter terminal when a voting is completed;
a vote token identification unit configured to assign an identification code to the issued vote token and store the identification code of the issued vote token; and
a block chain unit configured to create a block of an authentication block chain network using the vote token provided from the voter terminal and the vote token provided to the voter terminal.

2. The vote authentication server of claim 1, wherein the vote token identification unit is configured to compare the identification code of the vote token provided to the voter terminal with the identification code of the vote token provided from the voter terminal to check whether a voter votes or not.

3. The vote authentication server of claim 1, wherein a block of the authentication block chain network is created through a practical byzantine fault tolerance (PBFT) consensus algorithm.

4. The vote authentication server of claim 1, wherein the vote token management unit is configured to transmit the vote token provided to the voter terminal to a vote server that receives a vote value.

5. The vote authentication server of claim 1, further comprising:
an encryption unit,
wherein the encryption unit is configured to encrypt the vote token provided to the voter terminal using a voter display key and an authentication server private key received from the voter terminal.

6. The vote authentication server of claim 1, wherein a vote result from the voter terminal is not received in the vote authentication server.

7. The vote authentication server of claim 1, wherein the vote token management unit is configured to grant one vote token to one voter in order to implement a principle of an equal election.

8. A vote server comprising:
a vote value management unit configured to receive a vote value for a vote result from a voter terminal; and
a vote server block chain unit configured to create a block of a vote server block chain network by using the vote value.

9. The vote server of claim 8, further comprising: a vote server vote token management unit configured to receive the vote token from an authentication server.

10. The vote server of claim 8, wherein the block of the vote server block chain network is created through a practical byzantine fault tolerance (PBFT) consensus algorithm.

11. The vote server of claim 8, further comprising:
a vote token management unit configured to receive the vote token from an authentication server,
wherein the vote value management unit is configured to receive the vote value and assign reliability to the vote value according to whether the vote token associated with the vote value matches the vote token received from the authentication server.

12. The vote server of claim 8, wherein the vote value management unit is configured to receive the vote value and the vote token associated with the vote value from the voter terminal such that a voter who creates the vote value is kept with a secret.

13. The vote server of claim 8, wherein the vote value management unit is configured to determine the vote value based on a difference in input values between an initial password input window and a vote password input window of the voter terminal.

14. An electronic voting system comprising:
an authentication server configured to issue a vote token according to a vote authority after receiving vote authority authentication request information transmitted from a voter terminal; and
a vote server configured to receive the vote token from the authentication server and receive a vote value for a vote result from the voter terminal,
wherein the voter terminal is configured to transmit a vote authority authentication request information to the authentication server, and receive the vote token from the authentication server before a voting, and provide the vote token to the authentication server and provide the vote value to the vote server when the voting is completed.

15. The electronic voting system of claim 14, wherein the authentication server is configured to create a block of an authentication block chain network using the vote token provided from the voter terminal,
the vote server is configured to create a block of a vote block chain network using the vote value provided from the voter terminal, and
the authentication block chain network and the vote block chain network are separate block chain networks that are independent from each other.
